(19) United States
(12) Patent Application Publication
(10) Pub. No.: US 2008/0301995 A1
(43) Pub. Date: Dec. 11, 2008

(54) DECOY SYSTEM AND METHOD

(76) Inventors: Ralph W. Brittingham, JR., Morehead city, NC (US); William Harris, Atlantic, NC (US)

Correspondence Address: EDWARD M. LIVINGSTON, PA, 963 TRAIL TERRACE DRIVE, NAPLES, FL, 34103, US

(21) Appl. No.: 11/758,911

(22) Filed: Jun. 6, 2007

(51) Int. Cl. A01M 31/06

(52) U.S. Cl. 43/3

(57) ABSTRACT

A decoy system (1) having a net (2) with a predetermined perimeter (3), at least one weight (7) secured to the net (2), at least one decoy (8) securable to the net (2) and straps (11) and (12) for securing the decoy(s) (8) to the net (2). The net (2) includes intersecting first strand and second strand netting elements (4 and 5) to form a plurality of intersections (6) within the perimeter (3) wherein the decoy(s) (8) are preferably secured thereto. To use the present invention, a person first secures a decoy (8) to the net (8) via the straps (11 and 12). Then, he or she places the net (2) into a body of water such that the decoy is located above a water surface (16). Because the decoy (8) is constructed so as to float, it remains atop the water surface (16). However, because the net (2) is weighted, the net (2) remains below the water surface (16) so as to not be visible to other people or animals.

### BACKGROUND OF THE INVENTION

This invention relates to decoy systems, more particularly, a decoy system and method for waterfowl that permits a user to set up a decoy system quickly and easily.

Currently, hunters use various types of decoy systems to assist in luring an animal to a specific area. The decoys are constructed so as to simulate a real-life version of the animal to be hunted. When hunting specifically for fowl wherein the fowl migrate to a body of water, such as ducks and geese oftentimes do, the decoys traditional have a weighted keel or anchor located on a bottom side of the decoy so as to permit the decoys to float on the body of water and remain in an upright position. A plurality of decoys are traditionally secured on a line and a plurality of lines are oftentimes used to increase the number of decoys located in a specific area, thereby increasing the attractiveness of the decoys.

Although use of the current decoys adequately captures the interest of the fowl to be hunted, there are several drawbacks to using such decoys. First, if a person is using a plurality of lines, the lines oftentimes become entangled with one another, thus requiring the user to ultimately untangle the lines, which is time-consuming and frustrating. Second, if more than one line is being used, each line must be positioned into the water, which is a time-consuming and tedious task. Finally, the task of securing each decoy on a line is also time-consuming as a person must determine an appropriate placement of the decoy on the line and then secure it in such position.

Thus, a need exists for a decoy system and method that permits a user to set up the decoy system quickly and easily.

The relevant prior art includes the following references:

| U.S. Pat. No. | | |
|---|---|---|
| (U.S. unless stated otherwise) | Inventor | Issue/Publication Date |
| 2,246,574 | Coe | Jun. 24, 1941 |
| 970,003 | Wethall | Sep. 13, 1910 |
| 4,120,110 | Aeschliman | Oct. 17, 1978 |
| 7,043,865 | Crowe | May 16, 2006 |
| 5,974,720 | Bowling | Nov. 02, 1999 |
| 5,074,071 | Dunne | Dec. 24, 1991 |
| 4,599,819 | Voges, Jr. et al. | Jul. 15, 1986 |

### SUMMARY OF THE INVENTION

The primary object of the present invention is to provide decoy system and method that permits a user to set up the decoy system quickly.

A further object of the present invention is to provide a decoy system that is easy to use.

An even further object of the present invention is to provide a decoy system that allows for use of a plurality of decoys.

A further object of the present invention is to provide a decoy system that may be used in a body of water.

The present invention fulfills the above and other objects by providing a decoy system having a net with a predetermined perimeter, at least one weight secured to the net, at least one decoy securable to the net and a means for securing the at least one decoy to the net. The net includes a plurality of intersecting first and second netting elements to form a plurality of intersections within the perimeter of the net wherein the decoy(s) are preferably secured thereto.

To use the present invention, a person first secures a decoy to the net via the means for securing. Then, he or she places the net into a body of water such that the decoy is located above a water surface. Because the decoy is constructed so as to float, it remains atop the water surface. However, because the net is weighted, the net remains below the water surface so as to not be visible to the waterfowl it is being used to attract.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of a decoy system of the present invention;

FIG. 2 is a bottom view of a first embodiment of a decoy used in conjunction with the decoy system of the present invention;

FIG. 3 is a bottom view of a second embodiment of a decoy used in conjunction with the decoy system of the present invention;

FIG. 4 is a side view of the embodiment of FIG. 3 secured to a net used in conjunction with the decoy system of the present invention;

FIG. 5 is a side view of a third embodiment of a decoy used in conjunction with the decoy system of the present invention; and

FIG. 6 is a perspective view of a decoy system of the present invention in use.

### DESCRIPTION OF THE PREFERRED EMBODIMENTS

For purposes of describing the preferred embodiment, the terminology used in reference to the numbered components in the drawings is as follows:

| | |
|---|---|
| 1. | decoy system, generally |
| 2. | net |
| 3. | perimeter |
| 4. | first netting strand element |
| 5. | second netting strand element |
| 6. | intersection |
| 7. | weight |
| 8. | decoy |
| 9. | weight line |
| 10. | bottom side |
| 11. | first strap |
| 12. | second strap |
| 13. | first fastening means |
| 14. | second fastening means |
| 15. | retaining means |
| 16. | clip |
| 17. | water surface |

With reference to FIG. 1, a perspective view of a decoy system of the present invention is shown. The decoy system 1 includes a net 2 having a predetermined perimeter 3 and a plurality of intersecting first strand netting elements 4 and second strand netting elements 5 to form a plurality of intersections 6 within the perimeter 3 of the net 2. The netting elements 4 and 5 are preferably secured to one another, although they may overlap or be interwoven with one another to form the net 2. Secured to the net 2, preferably via weight lines 9, are weights 7. At least one decoy 8, which is preferably in the shape of a duck but which may also be in the shape of other fowl, animals and the like, is secured to the net 2, preferably on an intersection 6. The strand netting elements 4 and 5 may be widely spaced from one another to form large spaces therein or narrowly spaced from one another to form a mesh.

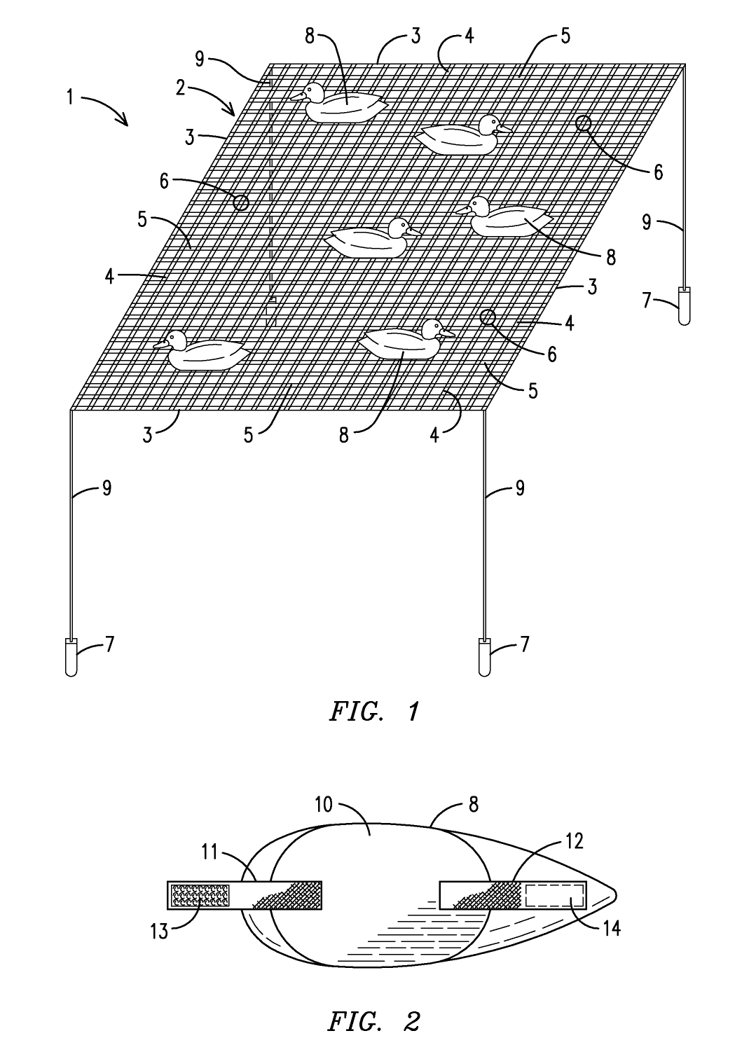

FIG. 2 shows a bottom view of a first embodiment of a decoy used in conjunction with the decoy system of the present invention. The decoy 8 has a bottom side 10 wherein a securing means, which is preferably a first strap 11 and a second strap 12, is secured thereto. Located on the first strap 11 is a first fastening means 13, which may be hook and loop type fastening material, and located on the second strap 12 is a second fastening means 14, which is preferably corresponding hook and loop type fastening material. In this manner, a person may easily secure the decoy 8 on the net 2, preferably on an intersection 6. Because the first fastening means 13 and second fastening means 14 are readily detachable from one another, a user may quickly install and remove a decoy 8 with minimal effort. In the alternative, a person may tie the first and second straps 11 and 12 to one another in order to secure the decoy 8 on the net 2.

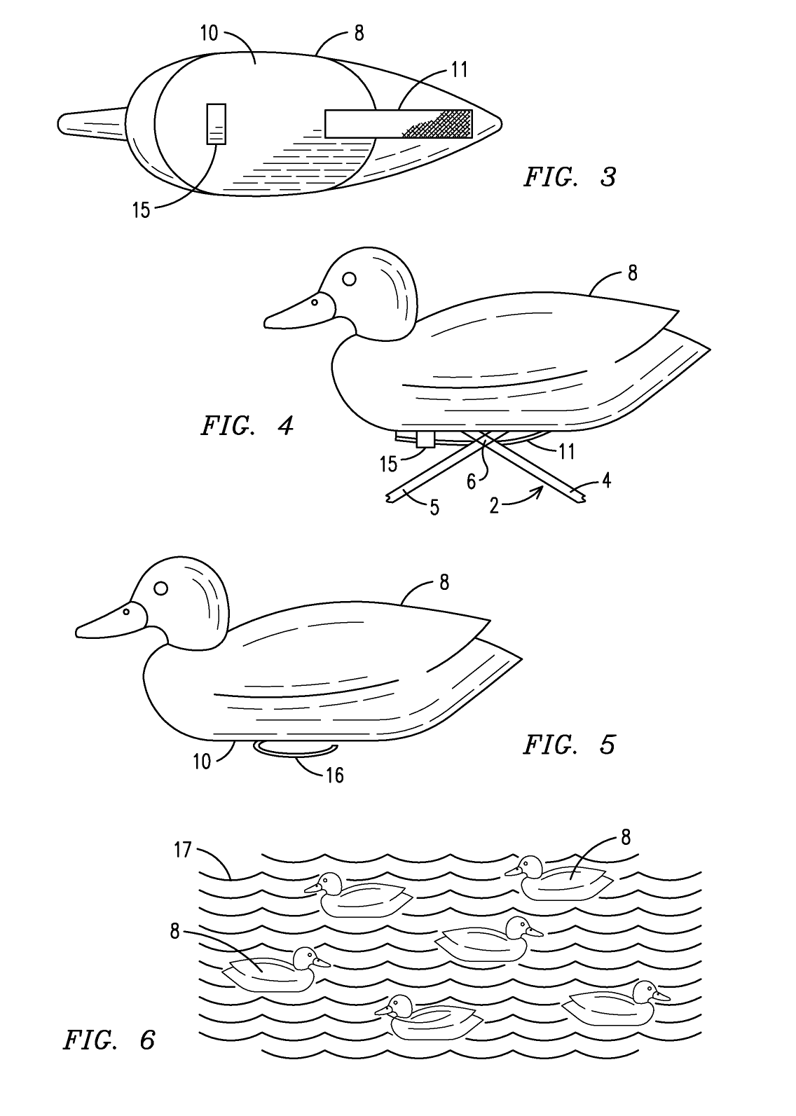

In FIG. 3, a bottom view of a second embodiment of a decoy used in conjunction with the decoy system of the present invention is shown. Rather than having a first and second strap 11 and 12 as in the first embodiment of the decoy 8, the second decoy 8 embodiment includes a first strap 11 and a retaining means 15 located on the bottom side 10 of the decoy 8. The retaining means 15 may be a buckle, clip, holder or any other device which may hold the first strap 11.

With reference to FIG. 4, a side view of the embodiment of FIG. 3 secured to a net used in conjunction with the decoy system of the present invention is shown. The first strap 11 is secured to the net 2 by placing the first strap 11 beneath an intersection 6 of the net 2 and securing the first strap 11 in the retaining means 15. Although the decoy 8 is constructed so as to float on a water surface (as shown in FIG. 6), the decoy 8 remains in substantially the same position when the decoy system 1 is placed in a body of water because the decoy 8 is secured to the net 2.

Next, FIG. 5 shows a side view of a third embodiment of a decoy used in conjunction with the decoy system of the present invention. Rather than having at least one strap, the third decoy 8 embodiment has a clip 16 located on the bottom side 10 of the decoy 8. The third decoy 8 embodiment is secured to the net 2 by positioning the clip 6 around a first netting element 4 or second netting element 5. However, the decoy 8 is preferably secured to an intersection 6 on the net 2.

Finally, FIG. 6 shows a perspective view of a decoy system of the present invention in use. Because the decoys 8 are constructed so as to float on a water surface 17, the decoys 8 remain in an upright position when placed in a body of water. However, because the net 2 includes at least one weight 7 secured thereto, the net 2 lowered a predetermined amount from the water surface 17, thus making the net 2 hidden from view of other waterfowl so the system appears to be a free-floating flock of waterfowl.

Although the decoy system 1 of the present invention is shown utilizing decoys 8 having a duck-like appearance, decoys 8 in other fowl-like or animal-like shapes may be used. In addition, other means for securing the decoy 8 to the net 2 may be used. Finally, although the net 2 is shown having a rectangular perimeter 3, the perimeter 3 may be of any shape, including, but not limited to, round, triangular, square and so forth.

The use of the present invention will allow a person to quickly and easily set up a decoy system.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A decoy system comprising:
a net having a predetermined perimeter;
at least one first strand netting element located within said perimeter;
at least one second strand netting element located within said perimeter;
at least one intersection formed by said at least one first strand netting element intersecting with said at least one second strand netting element;
at least one weight secured to said net;
at least one decoy securable to said net; and
a means for securing said at least one decoy to said net located on said at least one decoy.

2. The decoy system of claim 1 wherein:
said at least one decoy is secured to said at least one intersection.

3. The decoy system of claim 1 wherein:
said means for securing said at least one decoy to said net is via at least one strap located on a bottom side of said at least one decoy.

4. The decoy system of claim 2 wherein:
said means for securing said at least one decoy to said net is via at least one strap located on a bottom side of said at least one decoy.

5. The decoy system of claim 3 further comprising:
at least one fastening means located on said at least one strap.

6. The decoy system of claim 4 further comprising:
at least one fastening means located on said at least one strap.

7. The decoy system of claim 4 further comprising:
at least one retaining means located on said bottom side for retaining said at least one strap.

8. The decoy system of claim 1 wherein:
said means for securing said at least one decoy to said net is via at least one clip.

9. The decoy system of claim 1 wherein:
said at least one decoy is in the shape of a duck.

10. The decoy system of claim 1 wherein:
said at least one weight is secured to said perimeter.

11. The decoy system of claim 13 further comprising:
at least one weight line extending between said at least one weight and said perimeter.

12. A decoy system comprising:
a net having a predetermined perimeter;
at least one first strand netting element located within said perimeter;
at least one second strand netting element located within said perimeter;
at least one intersection formed by said at least one first strand netting element intersecting with said at least one second strand netting element;
at least one weight line extending from said perimeter;
at least one weight secured to said at least one weight line;
at least one decoy securable to said at least one intersection;
said at least one decoy has a bottom side; and
at least one strap is secured to said bottom side.

13. The decoy system of claim 12 wherein:
at least one fastening means located on said at least one strap.

14. The decoy system of claim 12 wherein:
said at least one decoy is in the shape of a duck.

15. The decoy system of claim 13 wherein:
said at least one decoy is in the shape of a duck.

16. A method of using a decoy system comprising a net having a predetermined perimeter; at least one first strand netting element located within said perimeter; at least one second strand netting element located within said perimeter; at least one intersection formed by said at least one first strand netting element intersecting with said at least one second strand netting element; at least one weight secured to said net; and a means for securing said at least one decoy to said net located on said at least one decoy, said method comprising the steps of:
a. securing said at least one decoy to said net; and
b. placing said net into a body of water such that said at least one decoy is located above a water surface.

17. The method of claim 16 further comprising a step after step b of:
c. removing said at least one decoy from said net.
